(19) United States
(12) Patent Application Publication
(10) Pub. No.: US 2014/0162501 A1
(43) Pub. Date: Jun. 12, 2014

(54) CONNECTOR

(71) Applicant: VITECK CO. LTD., Taoyuan City (TW)

(72) Inventor: Chih-Chun LIN, Taipei City (TW)

(73) Assignee: VITECK CO. LTD., Taoyuan City (TW)

(21) Appl. No.: 13/972,046

(22) Filed: Aug. 21, 2013

(30) Foreign Application Priority Data
Dec. 6, 2012 (TW) 101223646

(51) Int. Cl. H01R 27/02

(52) U.S. Cl. CPC H01R 27/02
USPC 439/660

(57) ABSTRACT

A connector is disclosed in this invention, comprising a connector body, a first terminal set, a second terminal set, and a third terminal set. The connector body comprises accommodating space, the accommodating space comprises a plug-in socket near one end of the connector body, and a side wall of the accommodating space close to the plug-in socket of the connector body is extended internally to form a protrusion. The first terminal set is installed inside the accommodating space and located near the other terminal of the connector body. The second terminal set is installed inside the accommodating space and located near the terminal of the connector body. The third terminal set is installed inside the accommodating space and located near the terminal of the connector body, and the second terminal set and the third terminal set are located at two sides of protrusion, respectively.

### CROSS REFERENCE TO RELATED APPLICATION

This application claims (priority from Taiwan Patent Application No. 101223646, filed on Dec. 6, 2012 in Taiwan Intellectual Property Office, the contents of which are hereby incorporated by reference in their entirety.

### BACKGROUND OF THE INVENTION

1. Field of the Invention

This invention is related to a connector, and particularly a connector designed to integrate a plurality of different access interfaces.

2. Description of the Related Art

Currently, electronic equipments have been widely used in various applications. With the tendency of developing light, thin, short, and small electron apparatuses, the connectors on the electron apparatuses must shrink their occupied space accordingly. In particular, when the requirement is to install a plurality of electrical connectors which are compliant to different electronic signal transmission protocols to allow different socket connectors to plug in, separation space between different connectors becomes a waste, since the installation of each electrical connector needs to occupy a fixed amount of space and more space is required to separate different electrical connectors.

It requires a lot of space for an electronic apparatus of providing audio/video entertainment to install different socket connectors, for example, the socket connector compliant to the specification of the Secure Digital Memory Card (SD card), the socket connector complaint to the specification of the High-Definition Multimedia Interface (HDMI), the socket connector compliant to the USB 3.0 specification, or a plurality of socket connectors compliant other specifications. Moreover, extra space is required to install the ear phone socket and the microphone socket.

Therefore, there is still a necessity to integrate a plurality of connectors, for example, the SD connector, the HDMI connector, and the USB connector, to save the occupied space. Simultaneously, it is also necessary to consider the situation of erroneous plug-in happened to the interface having the SD, HDMI, and USB connectors. This is the direction of improvement where the technical people of this area desire to pursue.

### SUMMARY OF THE INVENTION

According to the problem of prior arts, the propose of the present invention is to provide a connector to solve the problem of installing a plurality of connectors, which are compliant to different electronic signal transmission protocols, on exterior of an electronic apparatus to cause waste of space and difficulty of downsizing or miniaturizing an electronic product in prior technologies.

Based on the purpose of the present invention, a connector is disclosed. The connector comprises a connector body, a first terminal set, a second terminal set, and a third terminal set. The connector body comprises accommodating space, the accommodating space comprises a plug-in socket near one end of the connector body, and a side wall of the accommodating space close to the plug-in socket of the connector body is extended internally to form a protrusion. The first terminal set is installed inside the accommodating space and located near the other terminal of the connector body. The second terminal set is installed inside the accommodating space and located near the terminal of the connector body. The third terminal set is installed inside the accommodating space and located near the terminal of the connector body, and the second terminal set and the third terminal set are located at two sides of the protrusion, respectively.

Furthermore, a first storage device is detachably electrically connected to the first terminal set and one end of the protrusion supports the first storage device.

Furthermore, the first storage device is detachably electrically connected to one end of first terminal set and the other end of the first terminal set is electrically connected to a motherboard of an electronic apparatus.

Furthermore, a second storage device is detachably electrically connected to one end of the second terminal set and the other end of the second terminal set is electrically connected to a motherboard of an electronic apparatus.

Furthermore, the input-output connection terminal is detachably electrically connected to one end of the third terminal set and the other end of the third terminal set is electrically connected to a motherboard of an electronic apparatus.

Furthermore, the connector body comprises a base and a casing, the base comprises a concave chute, a first extension part and a second extension part are extended outward from the base near one end of the plug-in socket, and the casing is partially encapsulated the base to form the accommodating space.

Furthermore, the second terminal set and the third terminal set are installed on the first extension part and the second extension part, respectively.

Furthermore, the connector further comprises a plurality of contact leaf springs which are installed on one side wall of the casing and the other side wall opposite to the side wall to correspond to the first extension part and the second extension part.

Furthermore, the plurality of contact leaf springs touch and movably fix the second storage device or the input-output connection terminal when the second storage device or the input-output connection terminal is detachably inserted into the plug-in socket.

Furthermore, the plug-in socket is separated into a first opening and a second opening via the protrusion, the first opening corresponds to the second terminal set, and the second opening corresponds to the third terminal set.

Furthermore, two ends of one side of the first opening is indented toward the first opening to form two bevels.

Furthermore, one side wall of the concave chute of the base is installed with a flexible member, the flexible member touches and movably fixes the first storage device when the first storage device is detachably inserted into the concave chute.

As mentioned above, the connector may have one or more characteristics and advantages as described below:

(1). The convenience of the connector of the present invention can be increased by integrating the socket connectors compliant to the specifications of the SD card and any two of the socket connectors which are compliant to the following specifications into a connector: HDMI, USB 2.0 (also including USB 3.0), displayport, External Serial Advanced Technology Attachment (eSATA), Thunderbolt, etc.

(2).The saving space purpose of the connector of the present invention can be achieved by integrating the socket connector compliant to the specifications of the SD card and any two socket connectors which are compliant to the following specifications into a connector: HDMI, USB 2.0 (also including USB 3.0), displayport, External Serial Advanced Technology Attachment (eSATA), Thunderbolt, etc.

(3). By the design of the protrusion in the plug-in socket of the connector, the SD card can be firmly fixed in the connector when a user is plugging in the SD card into the connector for data access.

### BRIEF DESCRIPTION OF THE DRAWINGS

FIG. 1 is a first diagram showing a connector of a first embodiment of the present invention.

FIG. 2 is a second diagram showing the connector of the first embodiment of the present invention.

FIG. 3 is a third diagram showing the connector of the first embodiment of the present invention.

FIG. 4 is a fourth diagram showing the connector of the first embodiment of the present invention.

FIG. 5 is a first diagram showing the structure of the connector body of the connector of the present invention.

FIG. 6 is a second diagram showing the structure of the connector body of the connector of the present invention.

FIG. 7 is a diagram showing a connector of a second embodiment of the present invention.

### DETAILED DESCRIPTION OF THE PREFERRED EMBODIMENTS

With reference to the drawings, thereafter, the preferred embodiments of the connector in accordance with the present invention are illustrated. In order to be understood easily, the same components in the following embodiments are labeled as the same numeral.

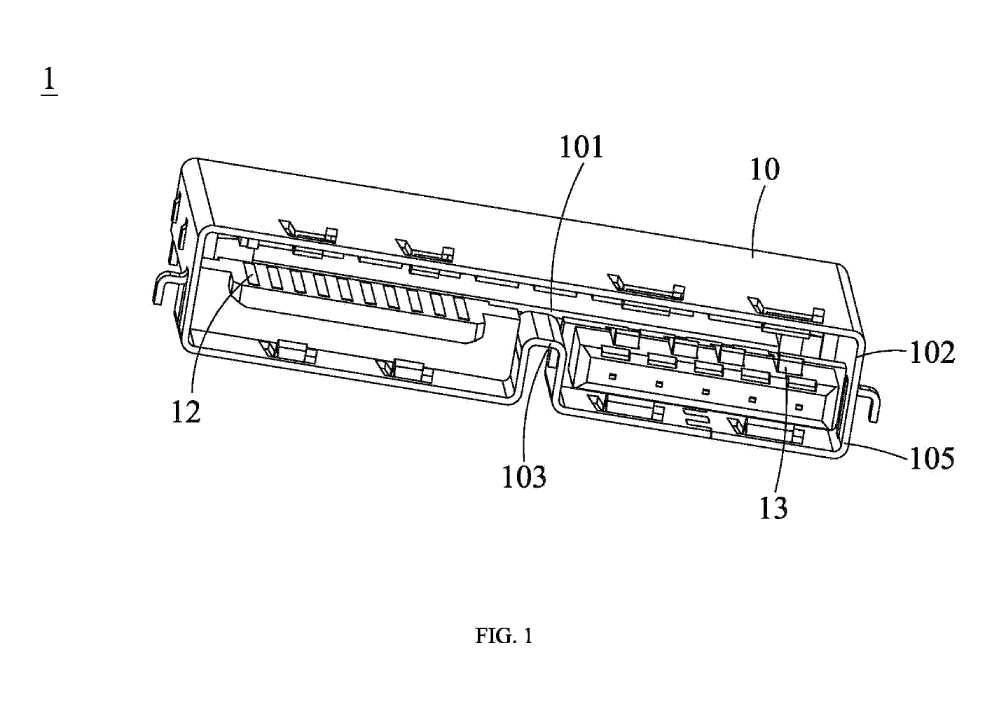

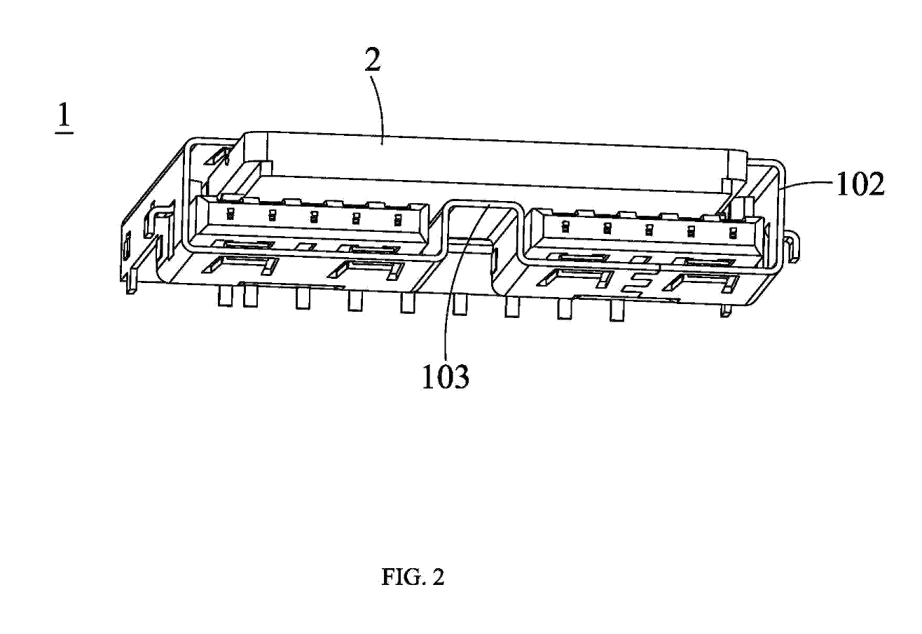

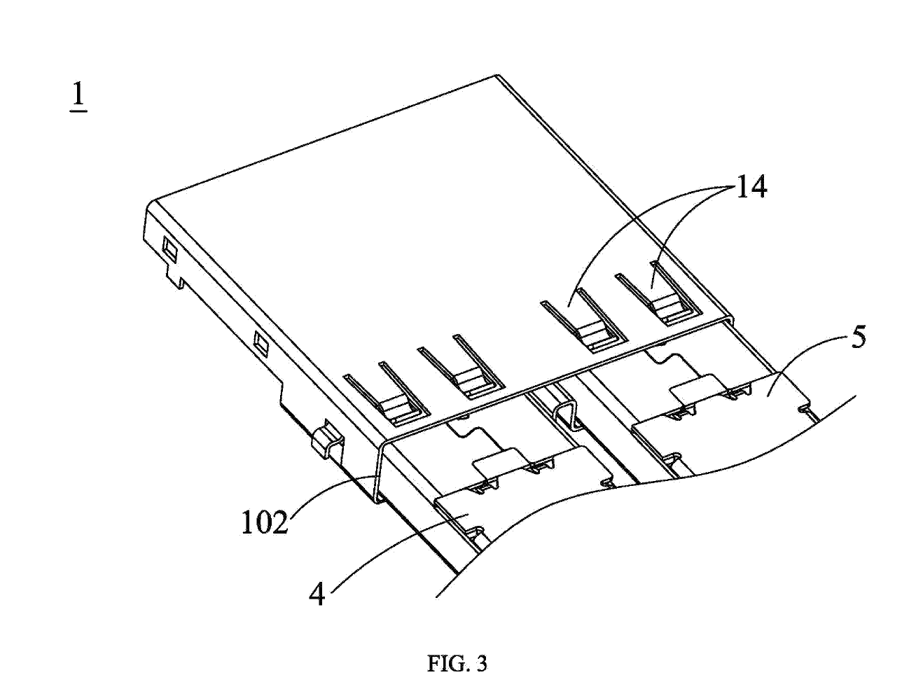

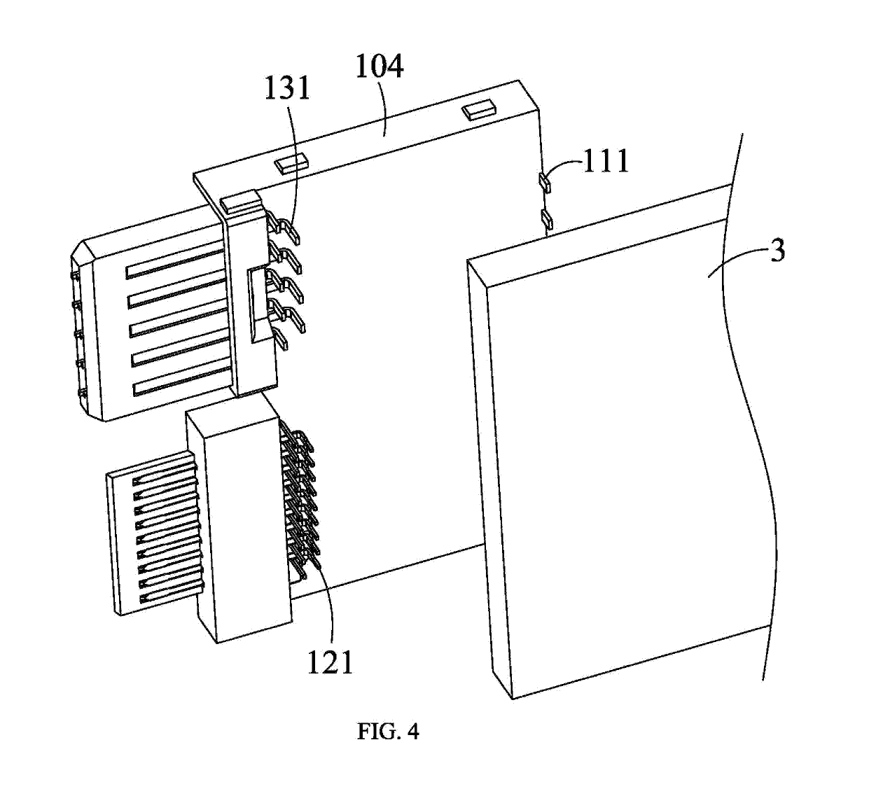

Referring to FIGS. 1-5, they are a first to a fourth diagrams showing a connector of a first embodiment of the present invention and a first diagram showing the structure of the connector body of the connector of the present invention. As shown in the figures, the connector 1 comprises a connector body 10, a first terminal set 11, a second terminal set 12, and a third terminal set 13. The connector body 10 comprises accommodating space 101, the accommodating space 101 comprises a plug-in socket 102 near one end of the connector body 10, and a side wall of the accommodating space 101 close to the plug-in socket 102 of the connector body 10 is extended internally to form a protrusion 103. The first terminal set 11 is installed inside the accommodating space 101 and located near the other end of the connector body 10. The second terminal set 12 is installed inside the accommodating space 101 and located near the end of the connector body 10. The third terminal set 13 is installed inside the accommodating space 101 and located near the end of the connector body 10, and the second terminal set 12 and the third terminal set 13 are located at two sides of protrusion 103, respectively.

In the above, a first storage device 2 is detachably electrically connected to the first terminal set 11 and one end of the protrusion 103 supports the first storage device 2. Besides, the first storage device 2 is detachably electrically connected to one end 110 of first terminal set 11 and the other end 111 of the first terminal set 11 is electrically connected to a motherboard 3 of an electronic apparatus.

Furthermore, a second storage device 4 is detachably electrically connected to one end 120 of the second terminal set 12 and the other end 121 of the second terminal set is electrically connected to the motherboard 3 of the electronic apparatus.

Moreover, the input-output connection terminal 5 is detachably electrically connected to one end 130 of the third terminal set 13 and the other end 131 of the third terminal set 13 is electrically connected to the motherboard 3 of the electronic apparatus.

For example, the connector 1 of the present invention can be installed in an electronic apparatus (not shown in the figures, the electronic apparatus can be a notebook computer or the mainframe of a personal computer), the other end 111 of the first terminal set 11 of the connector 1, the other end 121 of the second terminal set 12, and the other end 131 of the third terminal set 13 are electrically connected to the motherboard 3 of the electronic apparatus, respectively, to provide an apparatus for a user to execute transmission or access to different access interfaces. Namely, if the user desires to access the data stored in the first storage device 2 (for example, a SD card), he or she can plug the first storage device 2 into the connector 1 via the plug-in socket 102 and allow the terminal set of the first storage device 2 to electrically connect to one end 110 of the first terminal set 11 of the connector 1, such that the electronic apparatus can execute data transmission with the first storage device 2. Moreover, one end of the protrusion 103 of the connector 1 is able to support the first storage device 2, such that the first storage device 2 can be firmly located inside the connector 1 and does not have interruption of data transmission or inflict damage on the terminal set of the first storage device 2 or the first terminal set 11 due to shaking.

On the other hand, if the user holds the second storage device 4 (for example, a USB device) and intends to execute data access, he or she may plug the second storage device 4 into the connector 1 via the plug-in socket 102 and allow the terminal set of the second storage device 4 to electrically connect to one end 120 of the second terminal set 12 of the connector 1, such that the electronic apparatus can execute data transmission with the second storage device 4. Besides, the user can also plug the input-output connection terminal 5 (for example, a socket compliant to the Mini HDMI specification) to a display apparatus (not shown in the figures) into the connector 1 via the plug-in socket 102 and reach electrical connection to one end 130 of the third terminal set 13, such that the electronic apparatus can execute electronic signal transmission to the display apparatus via the input-output connection terminal 5 and display related message on the display apparatus. In this approach, the purpose of the electronic apparatus to execute simultaneous transmission with the second storage device 4 and the input-output connection terminal 5 of different electronic signals is achieved.

Besides, the connector 1 of the present embodiment can also be equipped with a second terminal set 12 compliant to the specification of the Memory Stick PRO (allows for larger maximum storage capacity and faster transmission speed), the Memory Stick Duo (a smaller format version of the Memory Stick, comprising the PRO Duo and the PRO-HG Duo), or the Memory Stick Micro (M2) which is smaller than the Duo or the PRO-HG which is faster than the PRO, etc. In this approach, the user is allowed to access the memory cards of the aforementioned specifications and enjoys the convenience of access the storage apparatuses of different specifications.

Moreover, terminal sets can also be installed on both the upper and lower sides of the first extension part and the second extension part of the connector of the present invention. In this approach, when the user plugs the second storage device or the input-output connection terminal into the connector, he or she may use the terminal sets installed on the first extension part or the second extension part to execute signal transmission. When the user does not plug the first storage device, the second storage device, and the input-output connection terminal into the connector, he or she may plug the Memory Stick Card (MS Card) into the connector and utilize the terminal sets installed beneath the first extension part or the second extension part to execute signal transmission. Moreover, the casing of the connector along with the first extension part or the second extension part are able to support the Memory Stick Card, such that the Memory Stick Card is firmly located within the connector and will not suffer interruption of data transmission due to shaking

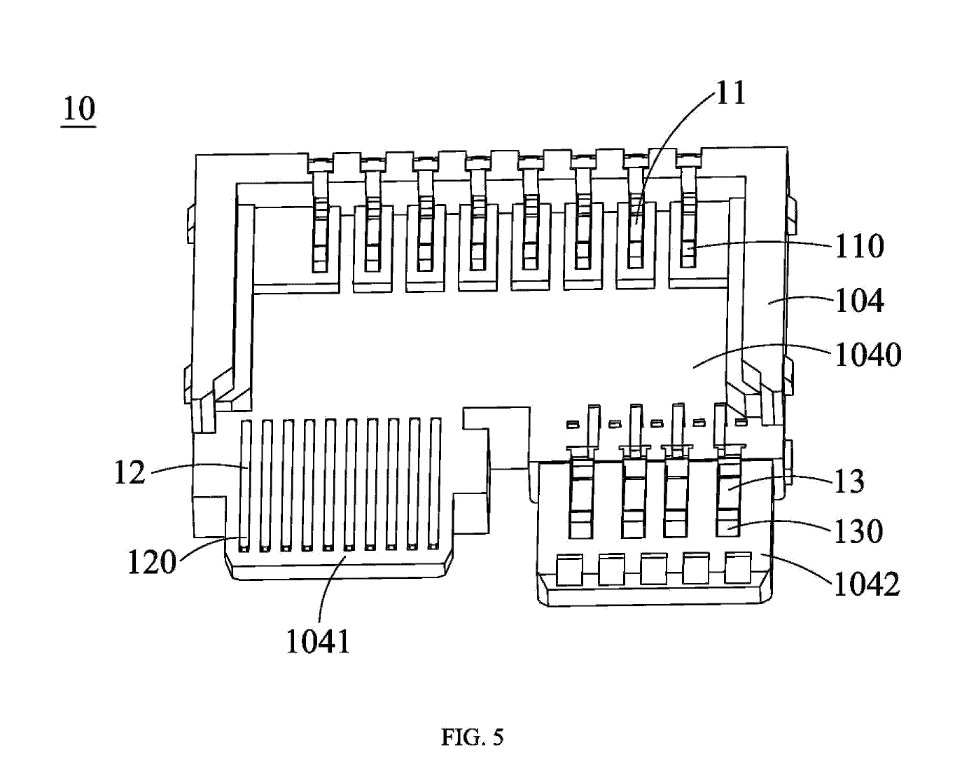

Referring to FIG. 5. As shown in the figure, the connector body 10 comprises a base 104 and a casing 105, the base 104 comprises a concave chute 1040, a first extension part 1041, and a second extension part 1042 are extended outward from the base 104 near one end of the plug-in socket 102, and the casing 105 is partially encapsulated the base 104 to form the accommodating space 101. Moreover, the second terminal set 12 and the third terminal set 13 are installed on the first extension part 1041 and the second extension part 1042, respectively.

The connector 1 further comprises a plurality of contact leaf springs 14, which are installed on one side wall of the casing 105 and the other side wall opposite to the side wall to correspond to the first extension part 1041 and the second extension part 1042. Moreover, the plurality of contact leaf springs 14 touch and movably fix the second storage device 4 or the input-output connection terminal 5 when the second storage device 4 or the input-output connection terminal 5 is detachably inserted into the plug-in socket 102.

Specifically, the base 104 of the connector body 10 of the present embodiment comprises a concave chute 1040, which can be used to hold the first storage device 2 when the user plug the first storage device 2 into the connector 1. Furthermore, a second terminal set 12 is installed on the first extension part 1041 and a third terminal set 13 is installed on the second extension part 1042. Therefore, when the user is plug the second storage device 4 and the input-output connection terminal 5 into the connector 1 respectively or simultaneously, the first extension part 1041 can enter the second storage device 4 and the second extension part 1042 can enter the input-output connection terminal 5. In this approach, the terminal set of the second storage device 4 is electrically connected to one end 120 of the second terminal set 12 of the connector 1 and the terminal set of the input-output connection terminal 5 is electrically connected to one end 130 of the third terminal set 13 of the connector 1.

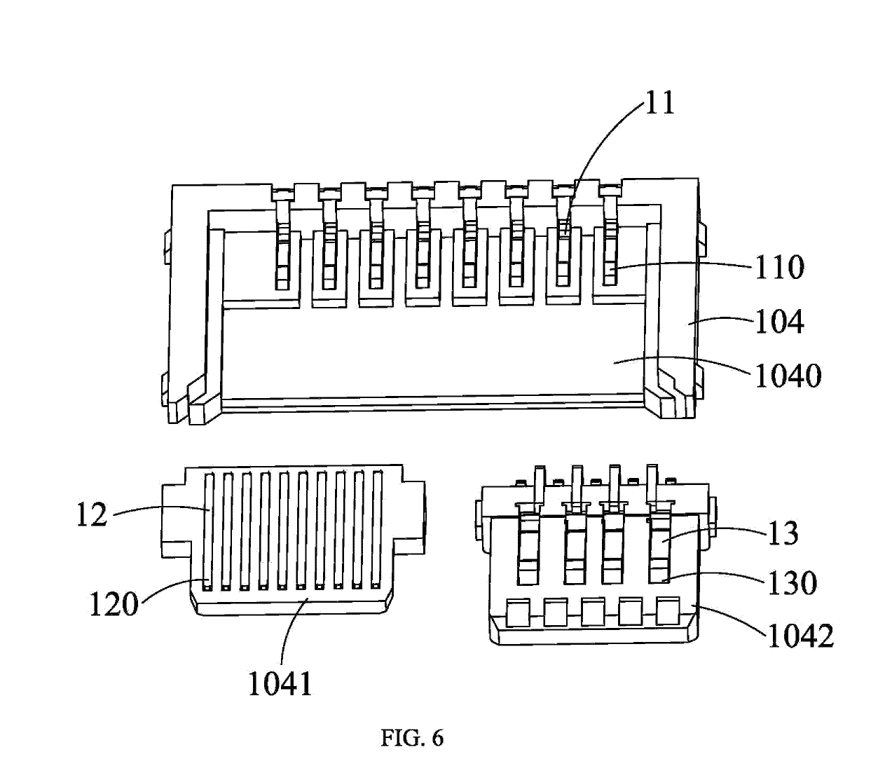

Referring to FIG. 6, FIG. 6 is a second diagram showing the structure of the connector body of the connector of the present invention. Moreover, the connector body 10 of the present embodiment also allows the base 104, the first extension part 1041, and the second extension part 1042 to be installed separately, such that the second terminal set 12 and the third terminal set 13 can be manufactured in modules. In this approach, the present invention can be more practical in production manufacturing.

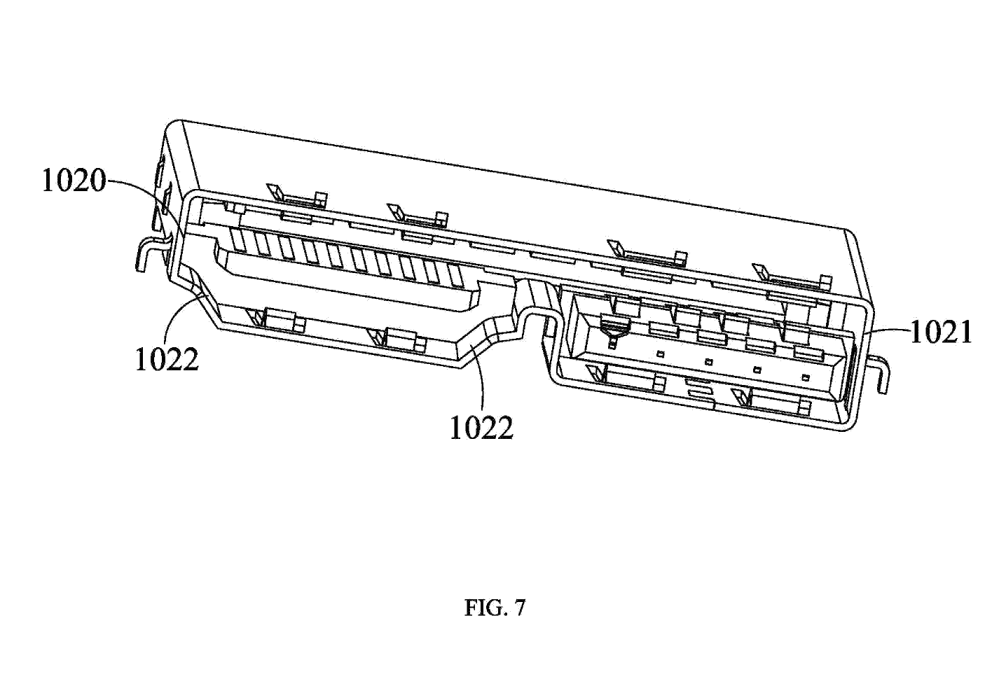

Referring to FIG. 7, FIG. 7 is a diagram showing a connector of a second embodiment of the present invention. Please also refer to FIGS. 1-4. As shown in FIG. 7, the operating methodology of the parts of the connector of the present embodiment is similar to that of the same parts in the aforementioned first embodiment and will not be repeated. However, it is noteworthy to mention that in the present embodiment the plug-in socket 102 of the connector 1 is separated into the first opening 1020 and the second opening 1021 via the protrusion 103, the first opening 1020 corresponds to the second terminal set 12, and the second opening 1021 corresponds to the third terminal set 13. Moreover, two ends of one side of the first opening 1020 is indented toward the first opening to form two bevels 1022.

Simply speaking, the two bevels 1022 formed on the first opening 1020 of the connector 1 in the present embodiment allows the user to firmly fix the input-output connection terminal 5 into the connector 1 when he or she is plugging the input-output connection terminal 5 of the display apparatus into the connector 1. More specifically, the structure conformability of the first opening 1020 to the shape of the socket of the input-output connection terminal 5 makes the input-output connection terminal 5 firmly locate inside the connector 1. Therefore, interruption of data transmission or damage on the terminal set of the input-output connection terminal 5 or the second terminal set 12 will not happen if any shaking occurs. It is noteworthy to mention that the above embodiments are merely exemplary, not limited. The present invention will not be limited to the aforementioned methods in practical implementation.

Besides, one side wall of the concave chute of the base can be further installed with a flexible buckle module in each of the above embodiments. Therefore, when the user is plugging the first storage device into the concave chute of the connector, the flexible buckle module can be movably hooked the first storage device 2 and make the first storage device fix in the concave chute. On the other hand, when the user finishes using the first storage device and wants to pull it out, he or she can also utilize the flexible buckle module 15 to eject the first storage device out of the concave chute. With the above, the convenience in practical use can be reached.

In addition, the connector of the present invention can also be installed with the second terminal set 12 or the third terminal set 13 compliant to the specifications of the displayport, the External Serial Advanced Technology Attachment (eSATA), or the Thunderbolt, etc.

The aforementioned preferred embodiment is to explain the technical ideas and features of the present invention. The purpose is to enable those who skilled in this technical area to understand the content of the present invention and realize it. It will be understood that the present invention is not limited to the details thereof. Various equivalent variations and modifications may still occur to those skilled in this art in view of the teachings of the present invention. Thus, all such variations and equivalent modifications are also embraced with the scope of the present invention as defined in the appended claim.

What is claimed is:

1. A connector, comprising:
a connector body, comprising accommodating space, and a plug-in socket being arranged in the accommodating space near one end of the connector body, and wherein a side wall of the accommodating space close to the plug-in socket of the connector body is extended internally to form a protrusion;
a first terminal set, being installed inside the accommodating space and located near other terminal of the connector body;
a second terminal set, being installed inside the accommodating space and located near the terminal of the connector body; and
a third terminal set, installed inside the accommodating space and located near the terminal of the connector body, wherein the second terminal set and the third terminal set are located at two sides of the protrusion, respectively; wherein the one end of the second terminal set is detachably electrically connected to a second storage device, one end of the third terminal end is detachably electrically connected to an input-output connection terminal, and the width of the protrusion is compatible with those of the connectors of the second storage device and the input-output connection terminal.

2. The connector of claim 1, wherein a first storage device is detachably electrically connected to the first terminal set and one end of the protrusion supports the first storage device.

3. The connector of claim 2, wherein the first storage device is detachably electrically connected to one end of first terminal set and the other end of the first terminal set is electrically connected to a motherboard of an electronic apparatus.

4. The connector of claim 1, wherein other end of the second terminal set is electrically connected to a motherboard of an electronic apparatus.

5. The connector of claim 4, wherein the other end of the third terminal set is electrically connected to the motherboard of the electronic apparatus.

6. The connector of claim 1, wherein the connector body comprises a base and a casing, the base comprises a concave chute, a first extension part and a second extension part are extended outward from the base near one end of the plug-in socket, and the casing is partially encapsulated the base to form the accommodating space.

7. The connector of claim 6, wherein the second terminal set and the third terminal set are installed on the first extension part and the second extension part, respectively.

8. The connector of claim 7, further comprising a plurality of contact leaf springs which are installed on one side wall of the casing and the other side wall opposite to the side wall to correspond to the first extension part and the second extension part.

9. The connector of claim 8, wherein the plurality of contact leaf springs touch and movably fix the second storage device or the input-output connection terminal when the second storage device or the input-output connection terminal is detachably inserted into the plug-in socket.

10. The connector of claim 6, wherein the plug-in socket is separated into a first opening and a second opening via the protrusion, the first opening corresponds to the second terminal set, and the second opening corresponds to the third terminal set.

11. The connector of claim 10, wherein two ends of one side of the first opening are indented toward the first opening to form two bevels.

12. The connector of claim 6, wherein one side wall of the concave chute of the base is installed with a flexible member, the flexible member touches and movably fixes the first storage device when the first storage device is detachably inserted into the concave chute.
